(19) United States
(12) Patent Application Publication
(10) Pub. No.: US 2008/0111273 A1
(43) Pub. Date: May 15, 2008

(54) Tool, Especially For the Extrusion of Plastics, Utilization of the Tool and Method For Recycling the Tool

(75) Inventor: Ralph Seelbach, Kempten (DE)

Correspondence Address: NORRIS, MCLAUGHLIN & MARCUS, P.A., 875 THIRD AVE, 18TH FLOOR, NEW YORK, NY, 10022, US

(73) Assignee: CFS Kempten GmbH, Kempten (DE)

(21) Appl. No.: 11/569,055

(22) PCT Filed: May 13, 2005
(86) PCT No.: PCT/EP05/05280

§ 371 Date: Aug. 13, 2007

(30) Foreign Application Priority Data
May 14, 2004 (DE) 10 2004 024 411.1

(51) Int. Cl. B29C 33/56

(52) U.S. Cl. 264/176.1; 425/224; 427/135

(57) ABSTRACT

A tool for the extrusion of films, having at least one coating, the at least one coating being at least partly a metal-nitride or transition metal nitride coating, or a combination thereof.

The present invention relates to a tool, especially for the extrusion of films or film layers, the tool at least partly having a coating.

Spiral mandrel tools, produced from various metal materials, are known. They are used for feeding and portioning free-flowing compositions. Spiral mandrel tools are used for example for producing multilayer shrink films with a barrier layer of PVDC (polyvinylidene chloride). The spiral mandrel tools thereby extrude a round film bubble. Especially when processing plastics containing PVC and PVDC, the chemical and abrasive wear of the tools is very great, especially of the mandrels, that is to say the parts of the tool by means of which for example a barrier layer for packaging films is formed from the plastics.

The object of the invention is to provide a tool for the extrusion of plastics, especially PVC or PVDC, which wears to a lesser extent and is inexpensive.

The object is achieved by a tool, especially for the extrusion of films, the tool at least partly having a coating which at least partly consists of metal nitride, transition-metal nitride or a mixture thereof, preferably chromium nitride and/or titanium nitride. As a result, the coated part of the tool, and especially the chromium nitride-coated part of the tool, has a surface which is very tough, chemically resistant and therefore not very susceptible to corrosion and which has a low tendency toward cold welding. Titanium nitride coatings are very hard and/or scarcely react with other materials. The coating protects this part of the tool from abrasion and corrosion being caused by a material processed with the tool. Therefore, the tool wears less quickly and to a lesser extent. Furthermore, the flow properties of the material processed with the tool are positively influenced by the smooth surface of the chromium nitride coating.

In a preferred embodiment, the coating is multilayered. As a result, defects of the individual layer of the coating are generally covered by another layer of the coating, so that the impermeability of the coating is increased by its multilayered nature and the coated part of the tool is even less susceptible to corrosion, and therefore even less susceptible to wear.

Depending on the material processed, the coating is preferably additionally coated with a final special coat. This is, for example, a very thin amorphous layer which brings about further smoothing of the surface coating.

With preference, the thickness of the coating is 2-30 pm, with particular preference 5-20 μm, with most particular preference 4-6 μm. Preferably, a coating about 5 μm thick has 30-40 layers. With particular preference, the metal or the transition metal is applied alternately in its pure form and then as a nitride. With most particular preference, the layer sequence is Cr/CrN/Cr/CrN and so on.

Preferably, the coating has a base layer, especially a nickel layer. Depending on the metal material used for the tool and the coating, the coating adheres better to the material of the tool as a result of the base layer.

In a preferred embodiment, the tool comprises an inner tool part and an outer tool part, the two tool parts forming a gap by being fitted one into the other, and preferably at least one side of the gap, with particular preference all sides of the gap, having the coating. When a material flows through the gap, the coated sides of the gap which form the tool parts are protected from abrasion and corrosion caused by the material processed with the tool. Furthermore, the flow properties of the material are positively influenced by the smooth surface of the coating. The quality of the product is improved as a result.

Advantageously, only the parts of the tool that come into contact with the material are coated, so that no unnecessary costs are incurred for the coating. The tool is especially suited for the extrusion and coextrusion of films, especially packaging films for food and especially for the production of a barrier layer of the packaging films, especially a barrier layer of PVC or PVDC.

With preference, the tool is a spiral mandrel tool for the processing of plastics. With particular preference, the inner tool part and the outer tool part are the mandrel of a spiral mandrel tool.

The coating is produced by means of CVD (chemical vapor deposition) or PVD (physical vapor deposition) processes.

A further subject matter of the present invention is the use of a tool, especially a spiral mandrel tool, or tool part, especially a mandrel, the tool or tool part at least partly having a corrosion-reducing coating, for the extrusion of plastics, especially of PVC or PVDC, preferably for the production of at least one layer of a film, especially a film for the production of food packagings. As a result, the wear of the tool or tool part is considerably less.

With preference, the coating is a chromium nitride coating. The use of a chromium nitride coating makes the surface of the coated part of the tool very smooth, very hard and chemically resistant. The flow properties of the plastic are improved by the smooth surface, and the lifetime and service life of the tool is prolonged considerably by the low wear. The tool is less susceptible to corrosion. Advantageously, the films produced are very smooth and uniform.

A further subject matter of the present invention is a method for renewing an uncoated and/or worn tool, especially a spiral mandrel tool, or tool part, especially a mandrel, characterized in that the tool or tool part is coated with a chromium nitride coating. A worn tool or tool part in the sense of the invention is a tool or tool part which, during the processing of the plastic, especially PVDC, causes such severe effects of wear, especially such severe expulsions of carbon, that the costs caused due to scrap are excessive or the process can no longer be carried out. Renewal allows a decommissioned tool or tool part to be used again. Since the application of the coating is considerably less expensive than the production of a new tool, very high costs can be saved by this method.

A further subject matter of the present invention is a method for reconditioning a tool according to the invention, especially a spiral mandrel tool, or tool part, especially a mandrel, at least one layer of the coating being removed and reapplied. A tool or tool part according to the invention can therefore be advantageously used a number of times without having to be newly produced. The method of removing at least one layer of the coating and reapplying a new layer is considerably less expensive in comparison with the production of a new tool or tool part. The tool or tool part is not damaged during the removal. The removal or stripping of the layer preferably takes place in a chemical bath.

The invention is described below on the basis of a FIGURE. The description is merely given by way of example and does not restrict the general concept of the invention.

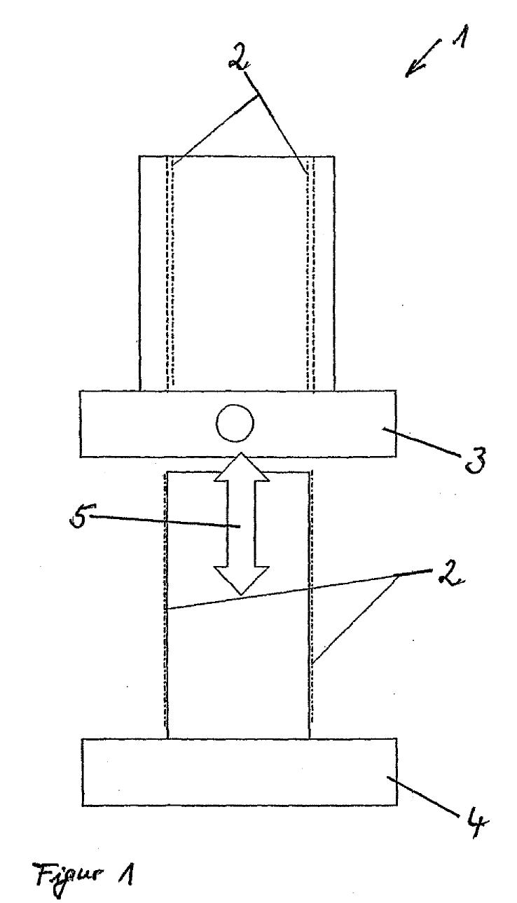

FIG. 1 shows an embodiment of a tool according to the invention.

FIG. 1 shows an embodiment of a tool 1 according to the invention. The tool 1 has an outer tool part 2 and an inner tool part 4, here two mandrels of a spiral mandrel tool which are pushed one into the other. This is indicated by an arrow 5. The tool parts 31 4 pushed one into the other form a gap, which with preference has a coating 2 at least on one side, here on all sides. The tool 1 is protected by the coating 2 from abrasion and corrosion, so that it wears less quickly.

Tools 1 according to the invention are protected by the coating 2 from corrosion and are therefore especially suited for the extrusion of plastics which contain PVC or PVDC. They extrude a round film bubble and are used for example for the production of multilayer shrink films with a barrier layer of PVDC (polyvinylidene chloride).

### List of Designations

1 tool

2 coating

3 outer tool part

4 inner tool part

5 direction in which the inner tool part is pushed into the outer tool part

1-9. (canceled)

9. A tool for the extrusion of films, said tool being at least partly coated, wherein the coating at least partly comprises a number of layers of metal nitride, transition metal nitride or a mixture thereof.

10. The tool of claim 9, wherein said metal nitride, transition metal nitride or mixture thereof are chromium nitride, titanium nitride or a mixture thereof.

11. The tool of claim 9, wherein said coating further comprising a base layer.

12. The tool of claim 11, wherein said base layer is a nickel layer.

13. The tool of claim 9, wherein said tool comprises an inner tool part and an outer tool part, said inner tool part and outer tool part being fitted one into the other and forming a gap, at least one side of said gap having said coating.

14. The tool of claim 13, wherein all sides of said gap have said coating.

15. The tool of claim 9, wherein said tool is a spiral mandrel tool for the processing of plastics.

16. A method for extruding a plastic, which comprises extruding said plastic through a spiral mandrel tool or a mandrel, said spiral mandrel tool or mandrel having a corrosion-reducing coating.

17. The method of claim 16, wherein said plastic is PVC or PVDC.

18. The method of claim 16, wherein said corrosion-reducing coating is a chromium nitride coating.

19. A method for renewing an uncoated spiral mandrel tool or mandrel, a worn spiral mandrel tool or mandrel or a spiral mandrel tool or mandrel which is both uncoated and worn, which comprises coating said uncoated, worn or uncoated and worn spiral mandrel tool or mandrel with a chromium nitride coating.

20. A method for reconditioning a tool of claim 9, which comprises removing and reapplying at least one layer of said coating.
